(19) United States
(12) Patent Application Publication
(10) Pub. No.: US 2018/0017212 A1
(43) Pub. Date: Jan. 18, 2018

(54) VEHICLE DEBRIS COLLECTION DEVICE

(71) Applicant: Susann Murphy, Avon, IN (US)

(72) Inventor: Susann Murphy, Avon, IN (US)

(21) Appl. No.: 15/211,045

(22) Filed: Jul. 15, 2016

(51) Int. Cl. F16N 31/00

(52) U.S. Cl. CPC F16N 31/006

(57) ABSTRACT

A debris collection device for placement under tires includes a pair of tracks. The tracks are separable, such that the tracks are positionable in parallel. Each track comprises a plurality of sections that is interlocking. Each section comprises a panel and a pair of sidewalls. The sidewalls are coupled singly to and extend substantially perpendicularly from opposing edges of the panel. A pair of stops is coupled singly to first ends of the tracks and defines a pair of catch areas. The stops are positioned to contact respective wheels of the vehicle as the vehicle is positioned on the tracks. The sections are interlocking such that the sections are positioned to form the tracks. Each track is configured to position a front and rear wheel of a vehicle, such that the vehicle is positioned over the tracks. The catch areas are configured to retain debris falling from the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to debris collection devices and more particularly pertains to a new debris collection device for placement under tires of a vehicle.

### BRIEF SUMMARY OF THE INVENTION

An embodiment of the disclosure meets the needs presented above by generally comprising a pair of tracks. The tracks are separable, such that the tracks are positionable in parallel. Each track comprises a plurality of sections that is interlocking. Each section comprises a panel and a pair of sidewalls. The sidewalls are coupled singly to and extend substantially perpendicularly from opposing edges of the panel. A pair of stops is coupled singly to first ends of the tracks and defines a pair of catch areas. The stops are positioned to contact respective wheels of the vehicle as the vehicle is positioned on the tracks. The sections are interlocking such that the sections are positioned to form the tracks. Each track is configured to position a front and rear wheel of a vehicle, such that the vehicle is positioned over the tracks. The catch areas are configured to retain debris falling from the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a debris collection device according to an embodiment of the disclosure.

FIG. 2 is a top view of an embodiment of the disclosure.

FIG. 3 is a side view of an embodiment of the disclosure.

FIG. 4 is an exploded view of an embodiment of the disclosure.

FIG. 5 is an in-use view of an embodiment of the disclosure.

### DETAILED DESCRIPTION OF THE INVENTION

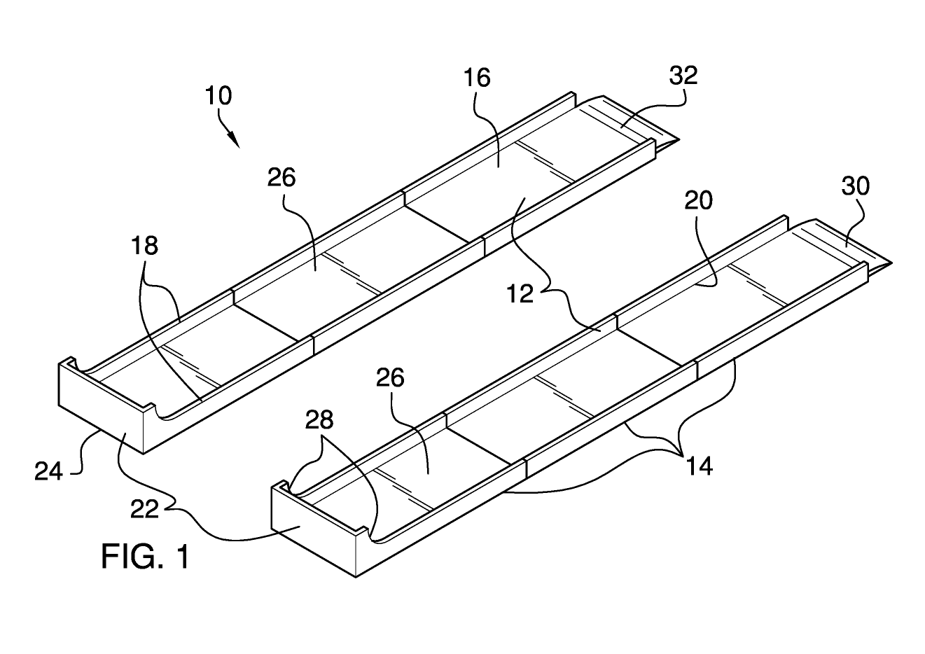

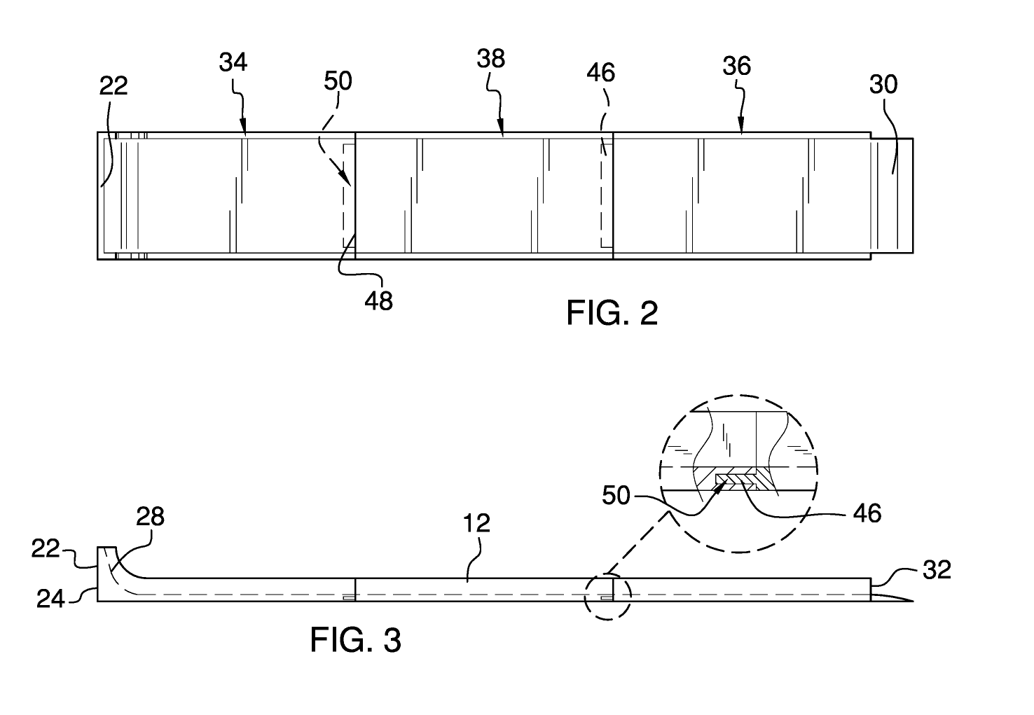

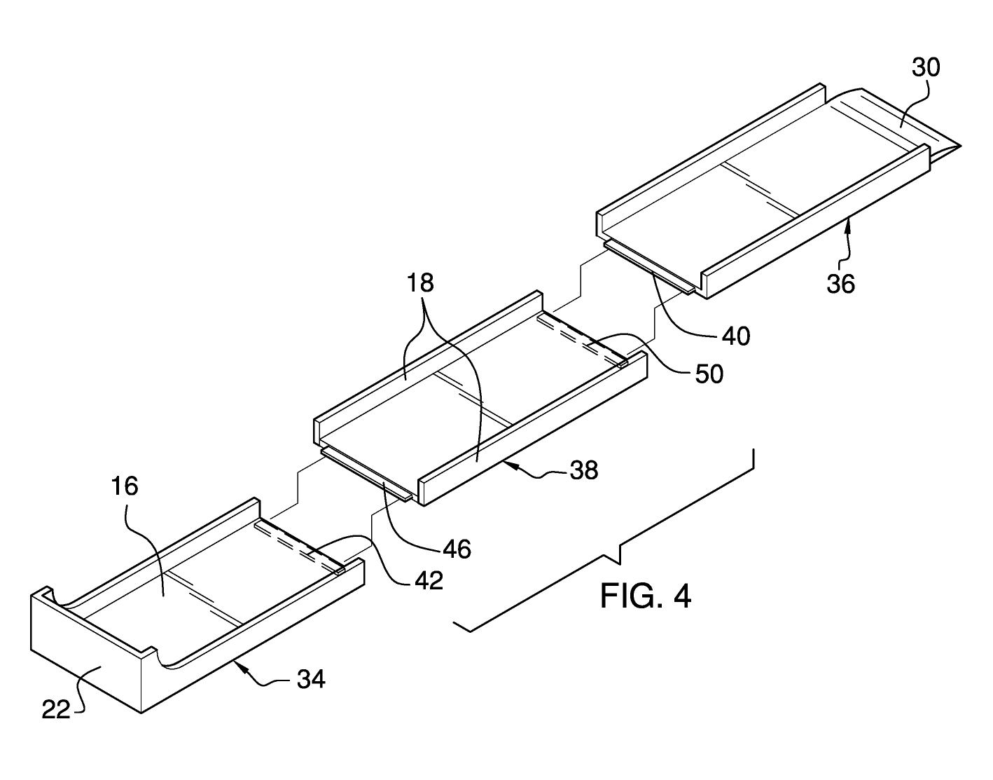

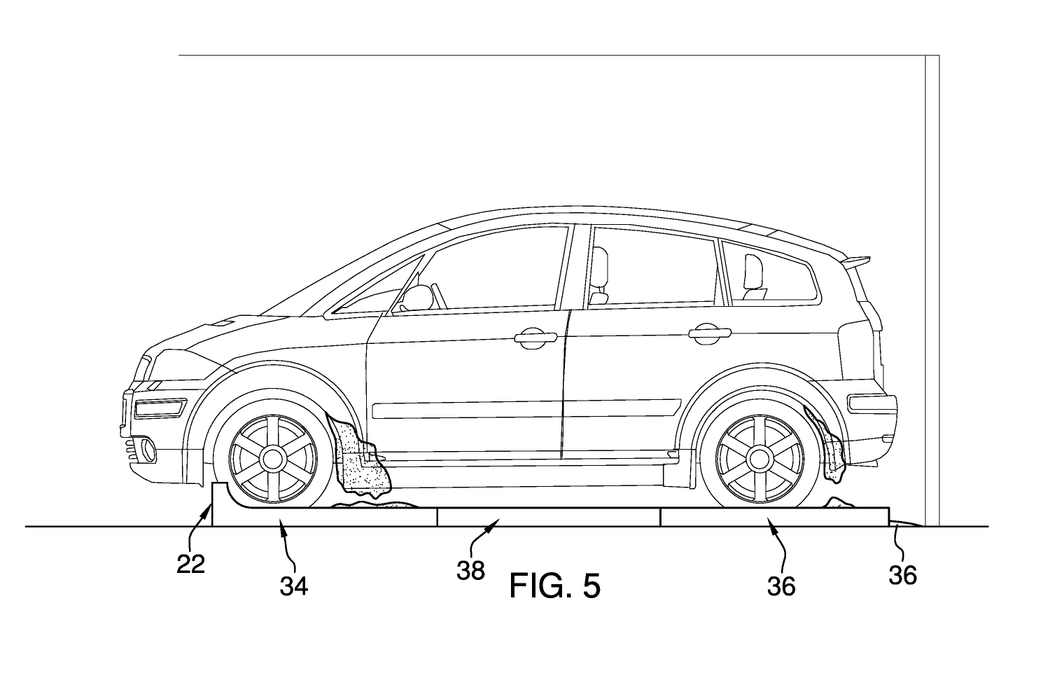

With reference now to the drawings, and in particular to FIGS. 1 through 5 thereof, a new debris collection device embodying the principles and concepts of an embodiment of the disclosure and generally designated by the reference numeral 10 will be described.

As best illustrated in FIGS. 1 through 5, the debris collection device 10 generally comprises a pair of tracks 12. The tracks 12 are separable, such that the tracks 12 are positionable in parallel. Each track 12 is configured to position beneath a front and rear wheel of a vehicle. Each track 12 comprises a plurality of sections 14 that is interlocking. Each section 14 comprises a panel 16 and a pair of sidewalls 18. The sidewalls 18 are coupled singly to and extend substantially perpendicularly from opposing edges 20 of the panel 16.

A pair of stops 22 is coupled singly to first ends 24 of the tracks 12, defining a pair of catch areas 26. The stops 22 are positioned to contact respective wheels of the vehicle as the vehicle is positioned on the tracks 12. Each stop 22 is coupled to a respective panel 16 and a respective pair of sidewalls 18. The stop 22 extends between the respective pair of sidewalls 18, such that the stop 22, the respective panel 16 and the respective pair of sidewalls 18 define a respective catch area 26. In one embodiment, the stop 22 is dimensionally taller than the respective pair of sidewalls 18, such that the stop 22 extends above the respective pair of sidewalls 18. In another embodiment, each track 12 comprises a pair of endcaps 28. Each endcap 28 is coupled to and extends between a respective stop 22 and a respective sidewall 18. In yet another embodiment, the endcaps 28 are arcuate.

Each track 12 comprises a ramp 30 that is coupled to and extends substantially coplanarly from a second end 32 of the track. The ramp 30 is positioned on the track 12 such that the ramp 30 is configured to facilitate rolling of the wheel onto the track. The ramp 30 also is configured to facilitate removal of debris collected within a respective catch area 26. In one embodiment, the ramp 30 is tapered, such that the ramp 30 is dimensionally thicker adjacent to the track 12 than distal from the track.

Each plurality of sections 14 comprises a forward segment 34, a rearward segment 36 and a plurality of medial segments 38. The forward segment 34 comprises a respective stop 22. The rearward segment 36 comprises a respective ramp 30. The plurality of medial segments 38 is positioned linearly between the forward segment 34 and the rearward segment 36. In one embodiment, the plurality of medial segments 38 comprises one medial segment 38.

The device 10 comprises a plurality of first couplers 40 and a plurality of second couplers 42. The plurality of first couplers 40 comprises first couplers 40 coupled singly to front ends 44 of each medial segment 38 and each rearward segment 36. In one embodiment, the first couplers 40 comprise tabs 46 that are coupled to and extend substantially coplanarly from the panel 16. The tabs 46 are positioned proximate to the opposing edges 20. The plurality of second couplers 42 comprises second couplers 42 coupled singly to rear ends 48 of each medial segment 38 and each forward segment 34. The second couplers 42 are complementary to the first couplers 40. Each second coupler 42 is positioned to couple to a respective first coupler 40 such that the plurality of sections 14 is interlocked to form the pair of tracks 12. In one embodiment, the second couplers 42 comprise slots 50 that are positioned in the panel 16.

In use, each second coupler 42 is positioned to couple to a respective first coupler 40 such that the plurality of sections 14 is interlocked to form the pair of tracks 12. Each track 12 is configured to position beneath a front and a rear wheel of a vehicle such that the vehicle is positioned over the tracks 12. The stops 22 are configured to contact respective wheels of the vehicle as the vehicle is positioned on the tracks 12. The catch areas 26 are configured to retain debris falling from the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A debris collection device comprising:
a pair of tracks, said plurality of tracks being separable, such that said plurality of tracks is positionable in parallel and such that each said track is configured for positioning of a front and rear wheel of a vehicle, each said track comprising a plurality of sections, said plurality of sections being interlocking, each said section comprising a panel and a pair of sidewalls, said pair of sidewalls being coupled singly to and extending substantially perpendicularly from opposing edges of said panel;
a pair of stops coupled singly to first ends of said plurality of tracks defining a pair of catch areas, wherein said pair of stops is configured to contact respective wheels of the vehicle as the vehicle is positioned on said plurality of tracks, each said stop being coupled to a respective said panel and a respective said pair of sidewalls, each said stop extending between said respective said pair of sidewalls, wherein each said stop, said respective said panel and said respective said pair of sidewalls define a respective said catch area, each said stop being dimensionally taller than said respective said pair of sidewalls, such that each said stop extends above said respective said pair of sidewalls; and
wherein said plurality of sections is interlocking such that said plurality of sections is positioned to form said plurality of tracks, wherein each said track is configured for positioning of a front and rear wheel of a vehicle such that the vehicle is positioned over said plurality of tracks, and wherein said pair of catch areas are configured to retain debris falling from the vehicle.

2. (canceled)

3. The debris collection device of claim 1, further including each said track comprising a pair of endcaps, each said endcap being coupled to and extending between a respective said stop and a respective said sidewall.

4. The debris collection device of claim 3, further including each of said endcaps being arcuate.

5. The debris collection device of claim 1, further including each said track comprising a ramp coupled to and extending substantially coplanarly from a second end of said track, wherein said ramp is positioned on said track such that said ramp is configured to facilitate rolling of the wheel onto said track, and wherein said ramp is configured to facilitate removal of the debris collected within a respective said catch area.

6. The debris collection device of claim 5, further including said ramp being tapered, such that said ramp is dimensionally thicker adjacent to said track than distal from said track.

7. The debris collection device of claim 5, further including each said plurality of sections comprising:
a forward segment comprising a respective said stop;
a rearward segment comprising a respective said ramp; and
a plurality of medial segments positioned linearly between said forward segment and said rearward segment.

8. (canceled)

9. The debris collection device of claim 7, further comprising:
a plurality of first couplers coupled singly to front ends of each said medial segment and each said rearward segment;
a plurality of second couplers coupled singly to rear ends of each said medial segment and each said forward segment, said plurality of second couplers being complementary to said plurality of first couplers; and
wherein each said second coupler is positioned to couple to a respective said first coupler such that said plurality of sections is interlocked to form said pair of tracks.

10. The debris collection device of claim 9, further comprising:
said plurality of first couplers comprising tabs coupled to and extending substantially coplanarly from said panel, said tabs being positioned proximate to said opposing edges; and
said second couplers comprising slots positioned in said panel.

11. A debris collection device comprising:
a pair of tracks, said pair of tracks being separable, such that said pair of tracks are positionable in parallel and such that each said track is configured for positioning of a front and rear wheel of a vehicle, each said track comprising a plurality of sections, said plurality of sections being interlocking, each said section comprising a panel and a pair of sidewalls, said pair of sidewalls being coupled singly to and extending substantially perpendicularly from opposing edges of said panel;
a pair of stops coupled singly to first ends of said tracks defining a pair of catch areas, wherein said pair of stops are configured to contact respective wheels of the vehicle as the vehicle is positioned on said pair of tracks, each said stop being coupled to a respective said panel and a respective said pair of sidewalls, said pair of stop extending between said respective said pair of sidewalls, wherein each said stop, said respective said panel and said respective said pair of sidewalls define a respective said catch area, each said stop being dimensionally taller than said respective said pair of sidewalls, such that said each stop extends above said respective said pair of sidewalls;
each said track comprising a pair of endcaps, each said endcap being coupled to and extending between a respective said stop and a respective said sidewall, each of said endcaps being arcuate;
each said track comprising a ramp coupled to and extending substantially coplanarly from a second end of said track, wherein said ramp is positioned on said track such that said ramp is configured to facilitate rolling of the wheel onto said track, and wherein said ramp is configured to facilitate removal of the debris collected within a respective said catch area, said ramp being tapered, such that said ramp is dimensionally thicker adjacent to said track than distal from said track;
each said plurality of sections comprising:
a forward segment comprising a respective said stop,
a rearward segment comprising a respective said ramp, and
a medial segment positioned linearly between said forward segment and said rearward segment;
a plurality of first couplers coupled singly to front ends of each said medial segment and each said rearward segment, said plurality of first couplers comprising tabs coupled to and extending substantially coplanarly from said panel, said tabs being positioned proximate to said opposing edges;
a plurality of second couplers coupled singly to rear ends of each said medial segment and each said forward segment, said plurality of second couplers being complementary to said plurality of first couplers, wherein each said second coupler is positioned to couple to a respective said first coupler such that said plurality of sections is interlocked to form said pair of tracks, said plurality of second couplers comprising slots positioned in said panel; and
wherein each said second coupler is positioned to couple to a respective said first coupler such that said plurality of sections is interlocked to form said pair of tracks, wherein each said track is configured for positioning of a front and rear wheel of a vehicle such that the vehicle is positioned over said pair of tracks, wherein said pair of stops are positioned to contact respective wheels of the vehicle as the vehicle is positioned on said pair of tracks, and wherein said pair of catch areas are configured to retain the debris falling from the vehicle.
